(19) United States
(12) Patent Application Publication
(10) Pub. No.: US 2009/0319062 A1
(43) Pub. Date: Dec. 24, 2009

(54) Apparatus for automatically registering topology of individual components of a process installation in automation technology

(75) Inventor: Alexander Schwalbe, Pforzheim (DE)

Correspondence Address: BACON & THOMAS, PLLC, 625 SLATERS LANE, FOURTH FLOOR, ALEXANDRIA, VA, 22314-1176, US

(73) Assignee: CodeWrights GmbH, Karlsruhe (DE)

(21) Appl. No.: 12/457,405

(22) Filed: Jun. 10, 2009

(30) Foreign Application Priority Data
Jun. 11, 2008 (DE) 10 2008 027846.7

(51) Int. Cl. G05B 19/05; G05B 19/042

(52) U.S. Cl. 700/86

(57) ABSTRACT

An apparatus for automatically registering topology of individual components of a process installation in automation technology. The components include field devices ascertaining or influencing physical and/or chemical, process variables. A superordinated control unit is provided, which communicates with the field devices via a fieldbus protocol conventional in automation technology and via which the field devices can be serviced. A radio tag is associated with each field device. Stored on the radio tag is topology-relevant information of the corresponding field device. A radio tag reader is provided, which registers the topology-relevant information of the radio tags and forwards such to the superordinated control unit.

### TECHNICAL FIELD

The invention relates to an apparatus for automatically registering topology of individual components of a process installation in automation technology. The components include, especially, field devices, which ascertain and/or influence physical and/or chemical, process variables.

### BACKGROUND DISCUSSION

In automation technology for processes, as well as such for manufacturing, field devices are often applied, which serve for registering and/or influencing process variables. Serving for registering process variables are measuring devices, such as, for example, fill level measuring devices, flow measuring devices, pressure, and temperature, measuring devices, pH measuring devices, conductivity measuring devices, etc., which register the corresponding process variables, fill level, flow, e.g. flow rate, pressure, temperature, pH value, or conductivity. Serving for influencing process variables are actuators, such as valves or pumps, via which e.g. the flow of a liquid in a pipeline, or the fill level of a medium in a container, is changed. Referred to as field devices are, in principle, all devices, which are applied near to the process and deliver or process information relevant to the process. A large number of such field devices are available from the members of the firm Endress+Hauser. Under the term, “field devices”, as used in connection with the invention, are, thus, subsumed all types of measuring devices and actuators.

In modern industrial plants, field devices are, as a rule, connected via bus systems, such as, for example, Profibus® PA, Foundation Fieldbus® or HART®, with at least one superordinated control unit. Normally, the superordinated control unit is, as already mentioned, a control system, or a control unit as already specified above in greater detail. The superordinated control unit serves for process control, process visualizing, process monitoring as well as start-up and servicing of the field devices. Programs, which run independently on superordinated units include, for example, the operating, or servicing, tools, FieldCare of Endress+Hauser, Pactware, AMS of Fisher-Rosemount or PDM of Siemens. Operating, or servicing, tools, which are integrated in control system applications, include PCS7 of Siemens, Symphony of ABB and Delta V of Emerson. The term, “servicing of field devices”, includes, especially, the configuring and parametering of field devices, however, also diagnosis for the purpose of early detection of malfunction at a field device or in the process.

The integration of field devices in object based, configuration, or management, systems occurs via device descriptions, which enable the superordinated units to recognize and interpret data delivered from the field devices. The device descriptions are provided by the manufacturers for each field device type, or for each field device type as a function of application. In order that the field devices can be integrated in different fieldbus systems, different device descriptions must be created for the different fieldbus systems. Thus, to name only some examples, there are HART, Fieldbus Foundation and Profibus, device descriptions.

For the purpose of creating a universal description for field devices, Fieldbus Foundation (FF), HART Communication Foundation (HCF) and Profibus User Organization (PNO) have developed a universal, electronic device description (EDD). The EDD is defined in the standard IEC 61804-2.

For a comprehensive servicing of field devices, moreover, special device descriptions, so called DTMs—Device Type Managers, or device managers—are obtainable. DTMs meet the FDT (Field Device Tool) specification. The FDT specification, which represents an industrial standard, is an interface specification and was developed by PNO, in cooperation with ZVEI, Zentralverband Elektrotechnik- und Elektroindustrie, or German Electrical and Electronics Manufacturers' Association. The current FDT specification is obtainable from ZVEI, or PNO, or the FDT-Group. Many field device manufacturers include with their field devices the corresponding DTMs or device descriptions. The DTMs encapsulate all device-specific data, functions and operating rules, such as e.g. the device structure, included communication possibilities and a graphical user interface, or GUI, for a certain field device or for a defined field device type.

As runtime environment, the DTMs require a frame application, here referred to as the FDT frame. The frame application and the corresponding DTMs permit a very user-friendly access to field devices, e.g. to device parameters, measured values, diagnostic information, status information, etc., as well as the invoking of special functions, which are available for individual DTMS. Frame application and DTMs form together an object based, management, or configuration, system for field devices. In order that the DTMs of different manufacturers correctly function in the frame application, the interfaces for frame application and the DTMs must be clearly defined. This interface definition falls under the acronym FDT. The FDT technology standardizes the communication interface between the field devices and the superordinated control unit. A special feature of the FDT technology is that it functions independently of the installed communication protocol as well as of the software environment both of the field device as well as also of the superordinated control unit. FDT enables interaction with any field devices via any superordinated control units with any protocols. A known FDT frame is the already mentioned product, FieldCare, of Endress+Hauser.

The topology of the field devices, just as with the setting of the communication parameters, must be manually implemented by an installation technician. The term, “communication parameters” refers, in connection with the invention, to the information dependent on the pertinent communication protocol. This information is used for the physical communication between the components, or participants, which are connected to the fieldbus. Thus, it is possible to address each field device connected to the fieldbus. For example, the address for the HART-protocol is a so-called “polling address”.

In addition to the manual installation, it is also possible to scan the topology of the field devices in the process installation via the fieldbus. In complex architectures, or topologies, this procedure is, however, very time intensive. Furthermore, it is to noted, that the scan function cannot be completely automated in the FDT application. This is especially the case, when the topology of the device objects has a number of different levels and is, thus, very complex.

### SUMMARY OF THE INVENTION

An object of the invention is to provide a ‘plug and play’ solution for the configuration of field devices in a process installation.

The object is achieved by features that: a superordinated control unit is provided, which communicates with field devices via a fieldbus protocol conventional in automation technology and via which the field devices can be serviced; each field device is provided with a radio tag; wherein topology-relevant information of a field device is stored on its radio tag; and a radio tag reader is provided, which registers the topology-relevant information of the radio tags and forwards such to the superordinated control unit.

Each field device in the process installation is provided with a relatively low cost, writable and readable, radio tag, a so-called RFID tag. For example, the installer of devices writes topology-relevant information and communication parameters with a writing device, or a writing/reading device, into the radio tags of the devices. Subsequently, newly installed field devices equipped with radio tags can be configured from a control unit.

In an advantageous, further development of the apparatus of the invention, corresponding device objects are associated with the field devices, wherein the device objects permit servicing of the field devices through the superordinated control unit. Running on the control unit is a predetermined operating system, into which a frame application for the device objects is integrated. The control unit utilizes the topology-relevant information, in order to integrate the device objects into the superordinated control unit, or into any target application.

Furthermore, it is provided, that a communication, device object is instantiated in the frame application. The communication, device object communicates with all radio tags and ascertains the topology-relevant information and the communication parameters of the field devices. The communication, device object creates in the frame application, on the basis of the information, a complete project describing the process installation.

The communication, device object is a device object, which enables communication according to a communication standard known in automation technology. The communication, device object converts abstract, communication transactions of a device object, or of a plurality of device objects, into the physical communication process. For example, a Profibus device object does not speak directly with the Profibus-driver, but, instead sends only a predefined Profibus communication transaction to the communication, device object and is, therewith, completely independent from the Profibus hardware. Since the communication, device object speaks directly with the low-level driver of the operating system, it is hardware dependent. In this way, it is possible to utilize always the same communication, device object, even when the communication hardware and, therewith, the communication, device object are different.

Moreover, an advantageous embodiment of the apparatus of the invention provides, that the communication, device object adds the device objects and, on occasion, other communication, device objects to the project in accordance with the topology-relevant information. Additionally, the communication, device object inserts the ascertained communication parameters for all newly instantiated device objects into the frame application.

The radio tag reader can be either a mobile or a stationary device.

Preferably, the device objects are device type managers or device descriptions, which comprehensively describe the field devices. The frame application is, preferably, an FDT frame.

Furthermore, according to a further development of the apparatus of the invention, it is provided, that the field devices and the superordinated control unit communicate with one another via a fieldbus or via a radio connection.

The superordinated control unit is a control system or a PLC (programmable logic controller). The control unit can be integrated into a PC or into a laptop. Often, the control unit is an object oriented, configuration and management system.

### BRIEF DESCRIPTION OF THE DRAWINGS

The invention will now be explained in greater detail on the basis of the appended drawing, the figures of which show as follows:

FIG. 1 schematic drawing of a communication network in automation technology;

FIG. 2 schematic drawing of information stored on a radio tag; and

FIG. 3 schematic drawing of an embodiment of the apparatus of the invention.

### DETAILED DISCUSSION IN CONJUNCTION WITH THE DRAWINGS

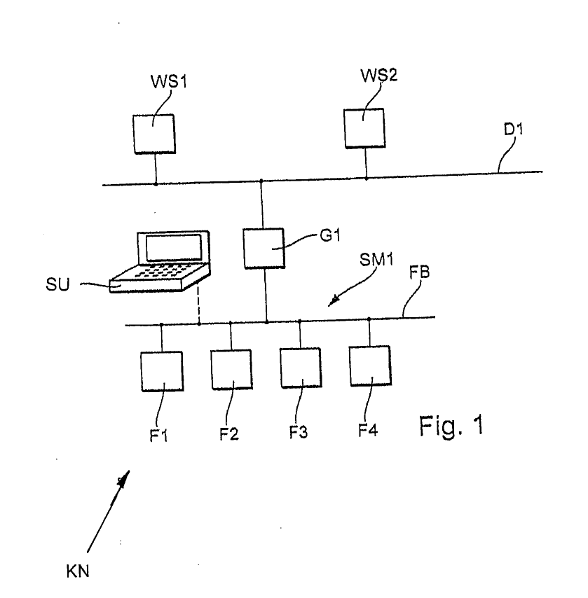

FIG. 1 shows schematically a communication network KN, such as is used in process automation. Connected to a data bus Dl are, here, a number of computer units (work stations, host computers) WS1, WS2. These computer units WS1, WS2 serve as superordinated units, or control structures (control system, control unit, servicing station SU) for process visualizing, process monitoring and for engineering, however, also, for servicing and monitoring of field devices F1, F2, . . . . Of course, even just one of the computer units, for example, the service unit SU, is sufficient for servicing the field devices.

Data bus D1 works e.g. according to the Profibus® DP standard, the HSE “High Speed Ethernet” standard of Foundation® Fieldbus, the HART standard or one of the known standards usable in automation technology. Via a gateway G1, which is also referred to as a linking device or segment coupler, the data bus D1 is connected with a fieldbus segment SM1. The fieldbus segment SM1 is composed of a plurality of field devices F1, F2, F3, F4, which are connected with one another via a fieldbus FB. The field devices F1, F2, F3, F4 are sensors and/or actuators. Also temporarily connectable with the fieldbus FB is a portable computer unit SU, e.g. a laptop, via which e.g. operating personnel can access individual field devices F1, F2, . . . .

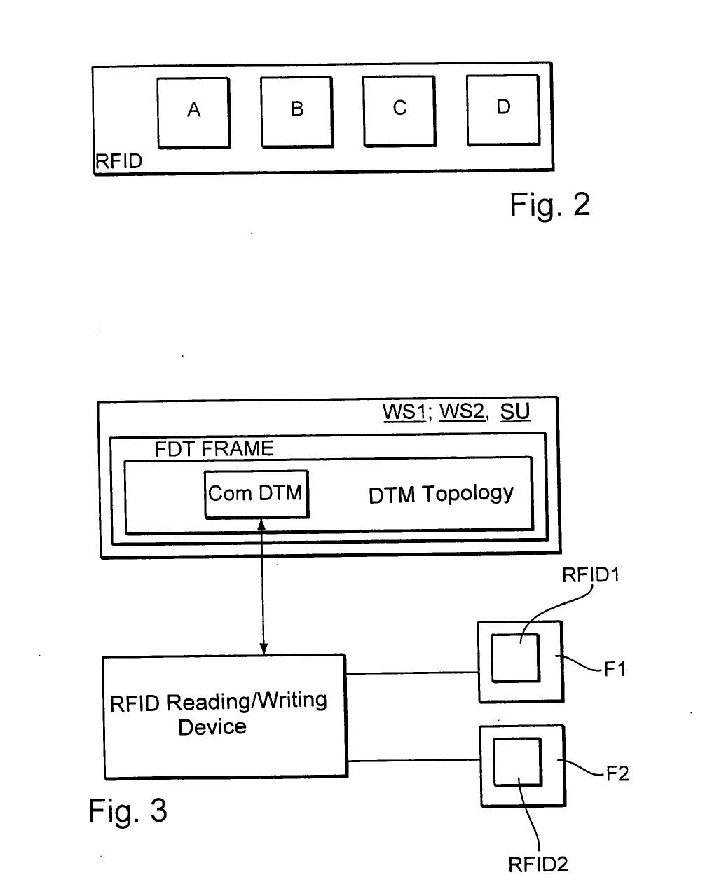

FIG. 2 is a schematic drawing of a radio tag RFID with information A, B, C, D stored thereon. In the illustrated case, the information designated with A is the address, or the so-called ‘tag’, of the associated field device, wherein such field device F1, F2, . . . is reached via this address. Label B designates the information concerning the address(es) or the tag, or tags, of at least one superordinated component of the communication network KN. This superordinated component is, for example, a multiplexer, with which the field device F1, F2, . . . is connected. Under C is the information on field device type, e.g. in the form of a device object DTM. In the case of the information stored under D, this is information concerning the type of fieldbus FB, e.g. Profibus PA.

The above described information is, for example, written, by means of suitable software in the RFID writing/reading device illustrated in FIG. 3, into the radio tag RFID by the installer of devices, who is installing a field device F1, F2, . . . newly into the process installation. Then, the newly installed field device F1, F2 can be configured e.g. from the service unit SU via the fieldbus.

FIG. 3 shows a schematic drawing of an embodiment of the apparatus of the invention, which, on the basis of device descriptions, or device objects DTM, enables an automatic topology management of a process installation and an automatic creating of the communication parameters. The term, “communication parameters” refers to special information dependent on the relevant communication protocol.

According to the invention, each field device F1, F2, . . . of a process installation is equipped with a writable radio tag RFID1, RFID2, . . . . The radio tags RFID1, RFID2, . . . store communication- and topology-relevant information, which classifies the field devices F1, F2, . . . sufficiently exactly in the topology of the communication network KN. An example is shown in FIG. 2. In this way, it is possible, by means of a fixedly installed or mobile, RFID, writing/reading device, automatically to generate the topology of the device objects DTM. For this, a special communication, device object ComDTM receives the current topology-relevant information from the RFID writing/reading device and creates, automatically, the project planning of the process installation in the FDT application. If communication parameters are changed or field devices F1, F2, . . . are removed from the process installation and, on occasion, replaced by new ones, or additional field devices are installed, then the communication, device object ComDTM changes the topology in accordance with the information delivered from the RFID writing/reading device. Also, according to a further development of the apparatus of the invention, an option is to utilize the communication, device object COM-DTM to write information into the radio tags RFID1, RFID2, . . . . It makes sense to do this, when the communication parameters or the topology of the process installation is to be changed. Furthermore it is provided, that the communication, device object COM-DTM changes or adapts the ‘content’ stored in the field devices.

Advantages of the apparatus of the invention include the following:
Automatic matching of the topology of a process installation is enabled in an FDT application. Project planning of the FDT application within the topology of the device objects DTM is omitted, since the topology can be automatically newly generated, at any time, corresponding to the current configuration of the communication network KN, with assistance of the communication, device object ComDTM.
The field devices F1, F2, . . . can be installed by operating personnel. All changes in the topology of the process installation can be automatically called up on all work stations WS1, WS2, SU connected to the communication network KN.
Detecting and generating the topology of the device objects DTM occurs automatically. A manual configuration can be omitted.
Already existing process plants can be retrofitted with the apparatus of the invention.

1-12. (canceled)

13. An apparatus for automatically registering topology of individual components of a process installation in automation technology, wherein the components include, field devices ascertaining or influencing physical and/or chemical, process variables, comprising:
a superordinated control unit is provided, which communicates with the field devices via a fieldbus protocol conventional in automation technology and via which the field devices can be serviced;
a radio tag is associated with each field device, wherein topology-relevant information of a field device is stored on its radio tag; and
a radio tag reader, which registers the topology-relevant information of said radio tags and forwards such to said superordinated control unit.

14. The apparatus as claimed in claim 13, further comprising:
corresponding device objects associated with the field devices, wherein said device objects permit servicing of the field devices by said superordinated control unit, wherein:
running on said superordinated control unit is a predetermined operating system, into which a frame application for said device objects is integrated; and
said superordinated control unit utilizes the topology-relevant information, in order to integrate said device objects into said superordinated control unit, or into a target application.

15. The apparatus as claimed in claim 14, further comprising:
a communication, device object instantiated in said frame application for communicating with all radio tags and for ascertaining topology-relevant information and communication parameters of the field devices, wherein:
said communication device object ascertains in the frame application, on the basis of the information, a complete project planning describing the process installation.

16. The apparatus as claimed in claim 15, wherein:
said communication, device object adds said device objects and, on occasion, other communication, device objects to the project in accordance with topology-relevant information;
said communication, device object inserts ascertained communication parameters for all newly instantiated device objects.

17. The apparatus as claimed in claim 13, wherein:
said communication, device object is a device object, which enables communication according to a communication standard known in automation technology.

18. The apparatus as claimed in claim 13, wherein:
said radio tag reader is a mobile or a stationary device.

19. The apparatus as claimed in claim 14, wherein:
said device objects are device type managers or device descriptions, which comprehensively describe the field devices.

20. The apparatus as claimed in claim 14, wherein:
said frame application is an FDT frame.

21. The apparatus as claimed in claim 13, wherein:
the field devices and said superordinated control unit communicate with one another via a fieldbus and/or via a radio connection.

22. The apparatus as claimed in claim 13, wherein:
said superordinated control unit is a control system or a PLC (programmable logic controller).

23. The apparatus as claimed in claim 22, wherein:
said superordinated control unit is integrated in a PC or in a laptop.

24. The apparatus as claimed in claim 13, wherein:
said superordinated control unit is an object oriented, configuration and management system.
